(19) United States
(12) Patent Application Publication
(10) Pub. No.: US 2024/0239717 A1
(43) Pub. Date: Jul. 18, 2024

(54) COMPOUND MICROBIAL FERTILIZER, AND PREPARATION METHOD AND APPLICATION THEREOF

(71) Applicants: SHIHEZI UNIVERSITY, Xinjiang (CN); JIANGSU GUOXIN UNION ENERGY CO., LTD, Jiangsu (CN)

(72) Inventors: FENGHUA ZHANG, Shihezi (CN); YAGUANG ZHAO, Shihezi (CN); FUXIN SUN, Wuxi (CN); ZHIJIE HU, Wuxi (CN); DONGJIAO ZHOU, Wuxi (CN)

(73) Assignees: SHIHEZI UNIVERSITY, Shihezi, XJ (CN); JIANGSU GUOXIN UNION ENERGY CO., LTD, Wuxi, JS (CN)

(21) Appl. No.: 17/782,669

(22) PCT Filed: Sep. 29, 2021
(86) PCT No.: PCT/CN2021/121649

§ 371 Date: Jun. 6, 2022

(30) Foreign Application Priority Data
Jul. 6, 2021 (CN) 202110762890. X

(51) Int. Cl. C05B 7/00

(52) U.S. Cl. CPC C05B 7/00

(57) ABSTRACT

The present invention discloses a compound microbial fertilizer, comprising citric acid fermentation raffinate, Arthrobacter fermentation liquid, urea, monoammonium phosphate and potassium sulphate; the proportion of each component is: (400-600) mL:(400-600) mL:(50-80) g:(50-80) g:(40-60) g; and the pH value of the compound microbial fertilizer is adjusted to 5.5-7.0 with ammonia water. The fertilizer can increase crop yield, promote crop growth, and improve the soil.

### TECHNICAL FIELD

The present invention relates to the technical field of microbial fertilizer, and more particularly to a compound microbial fertilizer, and a preparation method and an application thereof.

### BACKGROUND

The citric acid is widely used in food, medicine, chemical industry and other industries as important chemical raw material and a food additive. The citric acid in the production process produces a large amount of raffinate, which mainly contains starch, protein, carbohydrates, various organic acids, ammonia nitrogen, fat, etc., with the concentration of 20000-30000 mg/L, and which belongs to highly concentrated organic wastewater. If discharged directly, the raffinate will pollute an environment and damage the soil.

The compound microbial fertilizer is a kind of fertilizer integrating the advantages of an organic fertilizer, a chemical fertilizer with a microbial fertilizer as a whole. The compound microbial fertilizer can not only provide necessary NPK and medium trace elements for crop growth, but also provide organic matter and beneficial microbial active bacteria for crops. After the fertilizer enters the soil, microbes multiply largely with the assistance of the organic matter, inorganic nutrients, water and temperature, so the living space of harmful microbial communities is reduced, thereby increasing the number of beneficial microbial floras in the soil. The microbial floras produce a large amount of organic acids, which can partially dissolve phosphorus and potassium elements that has been deposited in the soil for many years and release for reuse by crops, so that the soil will become looser and richer after long-term use.

At present, the organic fertilizer in the compound microbial fertilizer is fermented mainly using livestock excrement as main raw material; however, the citric acid fermentation raffinate contains abundant carbon sources, nitrogen sources, inorganic salt and varied ingredients, which can exactly meet the needs for crop growth. If the compound microbial fertilizer is prepared using the citric acid fermentation raffinate as the main raw material, the environmental pollution due to the waste liquid can be effectively avoided, and waste materials can be utilized, which meets the needs for the crop growth.

Therefore, the problem to be urgently solved by those skilled in the art is how to prepare the compound microbial fertilizer using the citric acid fermentation raffinate as the main raw material and apply the fertilizer to the soil for promoting the crop growth.

### SUMMARY

In view of this, the present invention provides a fertilizer, which can increase crop yield, promote crop growth, and improve the soil.

To achieve the above purpose, the present invention adopts the following technical solution:
a compound microbial fertilizer comprises citric acid fermentation raffinate, Arthrobacter fermentation liquid, urea, monoammonium phosphate and potassium sulphate: the proportion of each component is: (400-600) mL:(400-600) mL:(50-80) g:(50-80) g:(40-60) g; and the pH value of the compound microbial fertilizer is adjusted to 5.5-7.0 with ammonia water.

As a preferred technical solution of the present invention, the organic matter content in the citric acid fermentation raffinate is 280-300 g/L.

As a preferred technical solution of the present invention, the viable count in the Arthrobacter fermentation liquid is greater than or equal to 0.5×10⁸ cfu/ml.

As a preferred technical solution of the present invention, the mass concentration of the ammonia water is 31-35%.

The technical solution has the advantageous effects that: in the citric acid fermentation raffinate, the organic matter content is 280.45 g/L, the humic acid content is 3.45 g/L, the total nitrogen content is 120.34 g/L, the total phosphorus content is 3.48 g/L, and the total potassium content is 20.67 g/L, and the citric acid fermentation raffinate is rich in nutrients and can provide good organic matter and inorganic ions for crop growth and development; the viable count in the Arthrobacter fermentation liquid is larger, and the Arthrobacterium can loosen the soil and promote the degradation of salt ions and heavy metal ions in the soil; and the urea, the monoammonium phosphate and the potassium sulphate can provide a nitrogen source, a phosphorus source and a carbon source for the soil. Therefore, for the compound microbial fertilizer of the present invention, the waste liquid in the process of citric acid fermentation is used as main raw material, which avoids the environmental pollution, and at the same time, because the Arthrobacter fermentation liquid has the characteristics of salt tolerance and drought tolerance, the strain fermentation liquid is mixed with the citric acid fermentation liquid raffinate, which can significantly promote crop growth and development and improve the soil.

A preparation method for the compound microbial fertilizer comprises the following steps:
1) preparing the Arthrobacter fermentation liquid: inoculating strains of activated Arthrobacter in a fermentation medium and fermenting in a shaker at 37° C., and at 180 r/min for 96 h, to obtain the Arthrobacter fermentation liquid;
2) weighing: weighing the citric acid fermentation raffinate, the Arthrobacter fermentation liquid, the ammonia water, the urea, the monoammonium phosphate and the potassium sulphate according to volume-mass ratio;
3) conducting primary mixing: adding the Arthrobacter fermentation liquid to the citric acid fermentation raffinate, to obtain the fermented mixed solution;
4) conducting secondary mixing: adding the urea, the monoammonium phosphate and the potassium sulphate to the fermented mixed solution and stirring until the homogeneous solution is produced, to obtain the mixed solution; and
5) adjusting the pH value: adding the ammonia water to the mixed solution and adjusting the pH value to 6.5, to obtain the compound microbial fertilizer.

As a preferred technical solution of the present invention, the fermentation medium comprises yeast extract, tryptone and distilled water, and the quality-volume ratio of the three is 1 g:2 g:200 ml.

As a preferred technical solution of the present invention, the pH value of the fermentation medium is 7.5-7.8.

As a preferred technical solution of the present invention, the pH value of the compound microbial fertilizer obtained through preparation is 5.5-7.0; and the content of the nitrogen, phosphorus and potassium in the compound microbial fertilizer is respectively 2.73%, 6.17% and 3.05%.

The compound microbial fertilizer prepared by the above preparation method is applied to improve the crop yield and promote the plant growth.

The compound microbial fertilizer prepared by the preparation method is applied to improve saline-alkali soil.

To sum up, the present invention has the beneficial effects:

The compound microbial fertilizer provided in the present invention can promote the growth and yield of tomatoes in nonsaline-alkali soil. Compared with the conventional fertilization, the application of the compound microbial fertilizer in the present invention can promote the fresh biomass and dry biomass of tomatoes, which are increased by 18.78% and 22.69% respectively, and single fruit weight is increased by 18.90% and the yield is increased by 13.11%. In addition, the application of the compound microbial fertilizer in the present invention can reduce the pH value of the soil and increase the content of rapidly available potassium, rapidly available phosphorus, organic matter and alkali-hydrolyzable nitrogen, and the increments are respectively 8.13%, 18.01%, 17.64% and 16.97%.

Moreover, the compound microbial fertilizer provided in the present invention can promote the growth and yield of cotton in non-saline-alkali soil. Compared with the conventional fertilization, and the application of the compound microbial fertilizer in the present invention can promote the fresh biomass and dry biomass of the cotton, which are increased by 19.92% and 24.25%. Compared with the conventional fertilization treatment, the number of bolls per individual plant is increased by 14.74%, boll weight per individual plant is increased by 12.38%, and unginned cotton yield is significantly increased by 41.43% under the condition of the application of the compound microbial fertilizer. In addition, compared with the conventional fertilization treatment, the pH of the soil is reduced by 7.09%, the EC is reduced by 25.83%, the organic matter is increased by 52.03%, the alkali-hydrolyzable nitrogen is increased by 42.31%, the rapidly available phosphorus is obviously increased by 46.46%, and the rapidly available potassium is increased by 32.45% under the condition of the application of the compound microbial fertilizer.

### DETAILED DESCRIPTION

The technical solution in the embodiment of the present invention will be clearly and fully described below. Apparently, the described embodiment is merely part of the embodiments of the present invention, not all of the embodiments. Based on the embodiments in the present invention, all other embodiments obtained by those ordinary skilled in the art without contributing creative labour will belong to the protection scope of the present invention.

### Embodiment 1 Preparing Compound Microbial Fertilizer

A preparation method for the compound microbial fertilizer comprises the steps:
1) preparing the Arthrobacter fermentation liquid: inoculating strains of activated Arthrobacter in a fermentation medium and fermenting in a shaker at 37° C., and at 180 r/min for 96 h, to obtain the Arthrobacter fermentation liquid;
2) weighing: weighing 400 ml of citric acid fermentation raffinate, 600 ml of Arthrobacter fermentation liquid, 50 g of urea, 80 g of monoammonium phosphate and 40 g of potassium sulphate, wherein the pH value of the citric acid fermentation raffinate is 2.87, the organic matter content is 280.45 g/L, humic acid content is 3.45 g/L, total nitrogen content is 120.34 g/L, total phosphorus content is 3.48 g/L and total potassium content is 20.67 g/L;
3) conducting primary mixing: adding the Arthrobacter fermentation liquid to the citric acid fermentation raffinate, to obtain the fermented mixed solution;
4) conducting secondary mixing: adding the urea, the monoammonium phosphate and the potassium sulphate to the fermented mixed solution and stirring until the homogeneous solution is produced, to obtain the mixed solution; and
5) adjusting pH value: adding the ammonia water with 32% of mass concentration to the mixed solution and adjusting the pH value to 5.5, to obtain the compound microbial fertilizer, wherein the content of nitrogen, phosphorus and potassium is respectively 2.33%, 4.23% and 3.06%.

### Embodiment 2

A preparation method for the compound microbial fertilizer comprises the steps:
1) preparing the Arthrobacter fermentation liquid: inoculating strains of activated Arthrobacter in a fermentation medium and fermenting in a shaker at 37° C., and at 180 r/min for 96 h, to obtain the Arthrobacter fermentation liquid;
2) weighing: weighing 500 ml of citric acid fermentation raffinate, 500 ml of Arthrobacter fermentation liquid, 70 g of urea, 70 g of monoammonium phosphate and 70 g of potassium sulphate, wherein the pH value of the citric acid fermentation raffinate is 2.87, the organic matter content is 280.45 g/L, the humic acid content is 3.45 g/L, the total nitrogen content is 120.34 g/L, the total phosphorus content is 3.48 g/L and the total potassium content is 20.67 g/L;
3) conducting primary mixing: adding the Arthrobacter fermentation liquid to the citric acid fermentation raffinate, to obtain the fermented mixed solution;
4) conducting secondary mixing: adding the urea, the monoammonium phosphate and the potassium sulphate to the fermented mixed solution and stirring until the homogeneous solution is produced, to obtain the mixed solution; and
5) adjusting the pH value: adding the ammonia water with 31% of mass concentration to the mixed solution and adjusting the pH value to 6.5, to obtain the compound microbial fertilizer, wherein the content of nitrogen, phosphorus and potassium is respectively 2.73%, 6.17% and 3.05%.

### Embodiment 3

A preparation method for the compound microbial fertilizer comprises the steps:
1) preparing the Arthrobacter fermentation liquid: inoculating strains of activated Arthrobacter in a fermentation medium and fermenting in a shaker at 37° C., and at 180 r/min for 96 h, to obtain the Arthrobacter fermentation liquid;
2) weighing: weighing 600 ml of citric acid fermentation raffinate, 400 ml of Arthrobacter fermentation liquid, 80 g of urea, 50 g of monoammonium phosphate and 60 g of potassium sulphate, wherein the pH value of the citric acid fermentation raffinate is 2.87, the organic matter content is 280.45 g/L, the humic acid content is 3.45 g/L, the total nitrogen content is 120.34 g/L, the total phosphorus content is 3.48 g/L, and the total potassium content is 20.67 g/L;
3) conducting primary mixing: adding the Arthrobacter fermentation liquid to the citric acid fermentation raffinate, to obtain the fermented mixed solution;
4) conducting secondary mixing: adding the urea, the monoammonium phosphate and the potassium sulphate to the fermented mixed solution and stirring until the homogeneous solution is produced, to obtain the mixed solution; and
5) adjusting the pH value: adding the ammonia water with 35% of mass concentration to the mixed solution and adjusting the pH value to 7.0, to obtain the compound microbial fertilizer, wherein the content of nitrogen, phosphorus and potassium is respectively 3.23%. 2.87% and 4.05%.

### Embodiment 4

### An Application of the Compound Microbial Fertilizer in Tomato Growth and Yield and Soil Improvement in Nonsaline-Alkali Soil

Under the same cultivation condition, cells are set up for comparative experiment, and CK is conventional field fertilization; treatment 1 is that the compound microbial fertilizer in Embodiment 1 of the present invention is applied; and treatment 2 is that the compound microbial fertilizer in Embodiment 2 of the present invention is applied; treatment 3 is that the compound microbial fertilizer in Embodiment 3 of the present invention is applied; and treatment 4 is that the compound microbial fertilizer on the market is applied. At a seedling stage, a flowering stage and a full bearing stage of tomatoes, 100 kg/mu of compound microbial fertilizer is applied respectively. 100 kg/mu of monoammonium phosphate is applied for CK. Then, the tomato biomass and yield and the soil basic nutrients under different treatments are tested in Shihezi total field, Xinjiang province. An experimental crop is tomatoes. There are 1612 varieties tested. A planting pattern is film mulching drip irrigation. The configuration is conducted with 1 film, 2 tubes and 2 lines. The plant spacing is 40 cm and the row spacing is 60 cm. The theoretical number of plants is 5.2*104 plants·hm⁻². The total irrigation amount is 150 m³ mu, the irrigation reaches 8 times, and the fertilizer is applied with water for 6 times.

### Determination of Tomato Biomass:

After tomatoes are first blossomed, the plants within 1 m*1 m=1 m² of each cell are dug out and brought back to a laboratory quickly, to measure the fresh biomass of tomatoes. Then the plants are processed in the fixing method at 105° C. for 30 min and baked at 70° C., to constant weight, and the dry biomass is determined. The results are shown in Table 1:

TABLE 1
Influences of Different Treatments on Tomato Biomass

| | Fresh Biomass | Dry Biomass |
|---|---|---|
| Grouping | (kg/mu) | (kg/mu) |
| CK | 421.23 | 257.34 |
| Compound microbial fertilizer | 443.32 | 279.62 |
| in Embodiment 1 | | |
| Compound microbial fertilizer | 500.35 | 315.73 |
| in Embodiment 2 | | |
| Compound microbial fertilizer | 456.38 | 296.62 |
| in Embodiment 3 | | |
| Compound microbial fertilizer | 489.63 | 289.54 |
| on the market | | |

As shown in Table 1, the application of the compound microbial fertilizer in Embodiment 1 can promote the fresh biomass and dry biomass of tomatoes, which are increased by 5.24% and 8.66% respectively compared with the conventional fertilization. The application of the compound microbial fertilizer in Embodiment 2 can promote the fresh biomass and dry biomass of the tomatoes, which are increased by 18.78% and 22.69% respectively compared with the conventional fertilization. The application of the compound microbial fertilizer in Embodiment 3 can promote the fresh biomass and dry biomass of the tomatoes, which are increased by 8.34% and 15.26% respectively compared with the conventional fertilization. The application of the compound microbial fertilizer on the market can promote the fresh biomass and dry biomass of the tomatoes, which are increased by 16.24% and 12.51% respectively compared with the conventional fertilization. The above results indicate that the application of the compound microbial fertilizer in embodiment 2 can promote the fresh biomass and dry biomass of the tomatoes to reach the optimum effect.

### Determination of Tomato Yield:

During tomato harvest, three 1 m*1 m=1 m² sampling points are taken randomly, the tomatoes are harvested, and the number of fruits and weight are recorded, thereby estimating the tomato yield. Tomato yield per mu=(the number of fruits per individual plant*single fruit weight*the number of plants per mu*correlation coefficient)/1000. The results are shown in Table 2:

TABLE 2
Influences of Organic Liquid Fertilizer
on Tomato Yield and Yield Components

| | the Number of | | |
|---|---|---|---|
| | Fruits Per | Single Fruit | Theoretical |
| | Individual Plant | Weight | Yield |
| Grouping | (Piece) | (g) | ((t/mu) |
| CK | 52 | 48.93 | 7.63 |
| Compound microbial | 51 | 50.23 | 7.96 |
| fertilizer in | | | |
| Embodiment 1 | | | |
| Compound microbial | 50 | 58.18 | 8.63 |
| fertilizer in | | | |
| Embodiment 2 | | | |
| Compound microbial | 50 | 56.36 | 8.01 |
| fertilizer in | | | |
| Embodiment 3 | | | |
| Compound microbial | 49 | 57.45 | 7.99 |
| fertilizer on the | | | |
| market | | | |

As shown in Table 2, the application of the compound microbial fertilizer in Embodiment 1 can significantly promote the tomato yield, and the single fruit weight is increased by 2.66% and the yield is increased by 4.33% by compared with the unapplied treatment. The application of the compound microbial fertilizer in Embodiment 2 can significantly promote the tomato yield, and the single fruit weight is increased by 18.90% and the yield is increased by 13.11% by compared with the unapplied treatment. The application of the compound microbial fertilizer in Embodiment 3 can significantly promote the tomato yield, and the single fruit weight is increased by 15.18% and the yield is increased by 4.98% by compared with the unapplied treatment. The application of the compound microbial fertilizer in Embodiment 3 can significantly promote the tomato yield, and the single fruit weight is increased by 15.18% and the yield is increased by 4.98% by compared with the unapplied treatment. The application of the compound microbial fertilizer on the market can significantly promote the tomato yield, and the single fruit weight is increased by 17.41% and the yield is increased by 4.71% by compared with the unapplied treatment. The above results indicate that the single fruit weight and the yield of tomatoes are increased at the maximum under the condition of the application of the compound microbial fertilizer in embodiment 2.

### Determination of Physical and Chemical Properties of Soil Sample

Soil samples without application of compound microbial fertilizer in the present invention and the soil samples in the application of compound microbial fertilizer in the present invention are collected at a seedling-pulling stage of tomatoes, and then are sieved via 1 mm and 0.15 mm screen after air drying. Determination of organic matter (by a potassium dichromate volumetric method), determination of pH value, determination of alkali-hydrolyzable nitrogen (by an alkaline hydrolysis diffusion method), determination of rapidly available phosphorus (by a molybdenum antimony resistance colorimetry method) and determination of rapidly available potassium (by a flame photometer method) are conducted on the soil successively. The results are shown in Table 3:

TABLE 3
Influences of Organic Liquid Fertilizer on Soil
Physical and Chemical Indexes of Tomato

| | | | Rapidly | Rapidly | | Alkali- |
|---|---|---|---|---|---|---|
| | | | Available | Available | Organic | hydrolyzable |
| | | EC | Potassium | Phosphorus | Matter | Nitrogen |
| Grouping | pH | μs/cm | (mg/kg) | (mg/kg) | (g/kg) | (mg/kg) |
| CK | 8.01 ± 0.1 | 0.29 ± 0.01 | 123.05 ± 23.48 | 54.46 ± 1.02 | 43.65 ± 1.40 | 20.50 ± 1.75 |
| Compound | 7.92 ± 0.41 | 0.32 ± 0.06 | 126.08 ± 10.60 | 56.65 ± 5.86 | 49.61 ± 3.12 | 21.65 ± 0.69 |
| microbial | | | | | | |
| fertilizer in | | | | | | |
| Embodiment | | | | | | |
| 1 | | | | | | |
| Compound | 7.89 ± 0.31 | 0.36 ± 0.01 | 133.06 ± 13.80 | 64.27 ± 9.88 | 51.35 ± 2.19 | 23.98 ± 0.53 |
| microbial | | | | | | |
| fertilizer in | | | | | | |
| Embodiment | | | | | | |
| 2 | | | | | | |
| Compound | 7.99 ± 0.31 | 0.31 ± 0.03 | 130.19 ± 10.69 | 61.63 ± 7.69 | 46.96 ± 3.16 | 21.69 ± 0.69 |
| microbial | | | | | | |
| fertilizer in | | | | | | |
| Embodiment | | | | | | |
| 3 | | | | | | |
| Compound | 7.93 ± 0.61 | 0.34 ± 0.03 | 129.01 ± 9.68 | 62.58 ± 8.69 | 46.65 ± 4.17 | 22.69 ± 0.57 |
| microbial | | | | | | |
| fertilizer on | | | | | | |
| the market | | | | | | |

As shown in Table 3, the application of the compound microbial fertilizer in embodiment 1 can reduce the pH value of the soil, and the amount of reduction is 1.12%; and the application can increase the content of rapidly available potassium, rapidly available phosphorus, organic matter and alkali-hydrolyzable nitrogen, and the increments are respectively 2.46%, 4.02%, 13.65% and 5.61%. The application of the compound microbial fertilizer in embodiment 2 can reduce the pH value of the soil, and the amount of reduction is 1.52%; and the application can increase the content of rapidly available potassium, rapidly available phosphorus, organic matter and alkali-hydrolyzable nitrogen, and the increments are respectively 8.13%, 18.01%, 17.64% and 16.97%. The application of the compound microbial fertilizer in embodiment 3 can reduce the pH value of the soil, and the amount of reduction is 0.25%; and the application can increase the content of rapidly available potassium, rapidly available phosphorus, organic matter and alkali-hydrolyzable nitrogen, and the increments are respectively 5.80%, 13.17%, 7.58% and 5.80%. The application of the compound microbial fertilizer on the market can reduce the pH value of the soil, and the amount of reduction is 0.10%; and the application can increase the content of rapidly available potassium, rapidly available phosphorus, organic matter and alkali-hydrolyzable nitrogen, and the increments are respectively 4.84%, 14.91%, 6.87% and 10.68%. The results show that the application of the compound microbial fertilizer can improve available nutrients of the soil, have soil fertility and improve soil quality, wherein the application of the compound microbial fertilizer in embodiment 2 has the optimum effect.

### Embodiment 5

### An Application of the Compound Microbial Fertilizer in Cotton Growth and Yield and Soil Improvement in Saline-Alkali Land

Under the same cultivation condition, the cells are set up for comparative experiments, and the basic physical and chemical properties of the cell are that: pH: 8.91, EC: 3.41 ms/cm, organic matter: 13.28 g/kg, alkali-hydrolyzable nitrogen: 13.92 mg/kg, rapidly available phosphorus: 20.92 mg/kg, and rapidly available potassium: 110.92 mg/kg.

The cotton biomass and yield and the soil basic nutrients are tested. Each treatment is repeated 3 times, with an area of 20 mu. The specific treatments are as follows:

The cells are set up for comparative experiment, and CK is conventional field fertilization; treatment 1 is that the compound microbial fertilizer in Embodiment 1 of the present invention is applied; and treatment 2 is that the compound microbial fertilizer in Embodiment 2 of the present invention is applied; treatment 3 is that the compound microbial fertilizer in Embodiment 3 of the present invention is applied; and treatment 4 is that the compound microbial fertilizer on the market is applied. At a seedling stage, a flowering stage and a full bearing stage of tomatoes, 100 kg/mu of compound microbial fertilizer is applied respectively. 100 kg/mu of monoammonium phosphate is applied for CK. The cotton adopts film mulching drip irrigation and mechanical direct-seeding methods. The configuration is conducted with 1 film, 3 tubes and 6 lines. The total irrigation amount is 350 m³ mu, the irrigation reaches 8 times and the fertilizer is applied with water for 7 times.

### Determination Method of Cotton Biomass:

After cotton is first blossomed, the cotton plants within 1 m*2.2 m=2.2 m² of each cell are dug out and brought back to a laboratory quickly, to measure the fresh biomass of the cotton. Then the plants are processed in the fixing method at 105° C. for 30 min and baked at 70° C. to constant weight, and the dry biomass is determined. The results are shown in Table 4.

TABLE 4
Influences of Different Treatments on Cotton Biomass

| | Fresh Biomass | Dry Biomass |
|---|---|---|
| Grouping | (kg/mu) | (kg/mu) |
| CK | 500.98 | 242.01 |
| Compound microbial | 520.36 | 263.62 |
| fertilizer in Embodiment 1 | | |
| Compound microbial | 600.78 | 300.71 |
| fertilizer in Embodiment 2 | | |
| Compound microbial | 580.69 | 289.59 |
| fertilizer in Embodiment 3 | | |
| Compound microbial | 589.63 | 286.69 |
| fertilizer on the market | | |

As shown in Table 4, the application of the compound microbial fertilizer in Embodiment 1 can promote the fresh biomass and dry biomass of cotton, which are increased by 3.87% and 8.93% respectively compared with the conventional fertilization. The application of the compound microbial fertilizer in Embodiment 2 can promote the fresh biomass and dry biomass of the cotton, which are increased by 19.92% and 24.25% respectively compared with the conventional fertilization. The application of the compound microbial fertilizer in Embodiment 3 can promote the fresh biomass and dry biomass of the cotton, which are increased by 15.91% and 19.66% respectively compared with the conventional fertilization. The application of the compound microbial fertilizer on the market can promote the fresh biomass and dry biomass of the cotton, which are increased by 17.70% and 18.46% respectively compared with the conventional fertilization. The above results indicate that the application of the compound microbial fertilizer in embodiment 2 has the optimum effect.

### Determination of Cotton Yield

After the boll opening of cotton, 1 m*2.2 m=2.2 m² of samples in each cell are taken randomly. The number of plants and the number of bolls are determined. A total of 100 bolls are harvested from upper, middle and lower layers of each cell. The cotton is dried and the average single boll weight is determined. Unginned cotton yield per mu=(the number of bolls*average boll weight)*the number of plants in a cell*300*0.85 (yield monitoring coefficient)/1000. The results are shown in Table 5:

TABLE 5
Influences of Different Treatments on Cotton Yield

| | the Number of | | |
|---|---|---|---|
| | Bolls Per | Single Boll | Unginned |
| | Individual Plant | Weight | Cotton Yield |
| Grouping | (Piece/Plant) | (g/Piece) | (kg/mu) |
| CK | 4.34 | 4.36 | 221.8 |
| Compound microbial | 4.56 | 4.68 | 268.6 |
| fertilizer in | | | |
| Embodiment 1 | | | |
| Compound microbial | 4.98 | 4.90 | 313.7 |
| fertilizer in | | | |
| Embodiment 2 | | | |
| Compound microbial | 4.81 | 4.79 | 298.3 |
| fertilizer in | | | |
| Embodiment 3 | | | |
| Compound microbial | 4.79 | 4.74 | 300.54 |
| fertilizer on the market | | | |

As shown in Table 5, compared with the conventional fertilization treatment, the number of bolls per individual plant of cotton is increased by 5.07%, the boll weight per individual plant is increased by 7.34%, and the unginned cotton yield is significantly increased by 21.10% under the condition of the application of the compound microbial fertilizer in embodiment 1. Compared with the conventional fertilization treatment, the number of bolls per individual plant of the cotton is increased by 14.74%, the boll weight per individual plant is increased by 12.38%, and the unginned cotton yield is significantly increased by 41.43% under the condition of the application of the compound microbial fertilizer in embodiment 2. Compared with the conventional fertilization treatment, the number of bolls per individual plant of the cotton is increased by 10.83% the boll weight per individual plant is increased by 9.86%, and the unginned cotton yield is significantly increased by 34.49% under the condition of the application of the compound microbial fertilizer in embodiment 3. Compared with the conventional fertilization treatment, the number of bolls per individual plant of the cotton is increased by 10.37%, the boll weight per individual plant is increased by 8.72%, and the unginned cotton yield is significantly increased by 35.48% under the condition of the application of the compound microbial fertilizer on the market. The results show that the application of the compound microbial fertilizer can increase the number of bolls per individual plant of the cotton and the boll weight per individual plant, thereby increasing the unginned cotton yield, wherein the number of bolls per individual plant, the boll weight per individual plant and the unginned cotton yield are increased at the maximum under the condition of the application of the compound microbial fertilizer in embodiment 2.

### Determination of Soil Sample

Soil samples from a soil layer near the distance of 10 cm from a drip irrigation zone are collected during the flowering and bolling stage of cotton, and three sampling points are taken for mixed samples, and then the samples are sieved via 1 mm and 0.15 mm screen after air drying. Then, the basic physical-chemical properties of the soil are determined: the organic matter is determined by the potassium dichromate volumetric method; the pH and conductivity are determined by an acid-base meter; the alkali-hydrolyzable nitrogen is determined by the alkaline hydrolysis diffusion method, the rapidly available phosphorus is determined by the molybdenum antimony resistance colorimetry method, and the rapidly available potassium is determined by the flame photometer method. During the flowering and bolling stage of cotton, the soil in an experimental field is sampled and determined. The results are shown in Table 6:

TABLE 6
Influences of Different Treatments on Each Index of
Soil at Peak Bolling Stage of Cotton

| | | | | Alkali- | Rapidly | Rapidly |
|---|---|---|---|---|---|---|
| | | | | hydro- | Available | Available |
| | | EC | Organic | lyzable | Phos- | Potas- |
| | | (ms/ | Matter | Nitrogen | phorus | sium |
| Grouping | pH | cm) | (g/kg) | (mg/kg) | (mg/kg) | (mg/kg) |
| CK | 8.91 | 3.41 | 13.28 | 13.92 | 20.92 | 110.92 |
| Compound | 8.56 | 2.86 | 14.36 | 16.41 | 23.56 | 121.96 |
| microbial | | | | | | |
| fertilizer in | | | | | | |
| Embodiment 1 | | | | | | |
| Compound | 8.32 | 2.71 | 20.19 | 19.81 | 30.64 | 146.91 |
| microbial | | | | | | |
| fertilizer in | | | | | | |
| Embodiment 2 | | | | | | |
| Compound | 8.68 | 2.89 | 16.39 | 18.69 | 28.65 | 132.36 |
| microbial | | | | | | |
| fertilizer in | | | | | | |
| Embodiment 3 | | | | | | |
| Compound | 8.46 | 2.74 | 15.69 | 17.16 | 25.48 | 132.56 |
| microbial | | | | | | |
| fertilizer on | | | | | | |
| the market | | | | | | |

As shown in Table 6, compared with the conventional fertilization treatment, the application of the compound microbial fertilizer in embodiment 1 can reduce the pH value of the soil by 3.93%, reduce EC by 16.13%, increase the organic matter by 8.13% increase the alkali-hydrolyzable nitrogen by 17.89%, significantly increase the rapidly available phosphorus by 12.62% and increase the rapidly available potassium by 9.95%. Compared with the conventional fertilization treatment, the application of the compound microbial fertilizer in embodiment 2 can reduce the pH value of the soil by 7.09%, reduce the EC by 25.83%, increase the organic matter by 52.03%, increase the alkali-hydrolyzable nitrogen by 42.31%, significantly increase the rapidly available phosphorus by 46.46% and increase the rapidly available potassium by 32.45%. Compared with the conventional fertilization treatment, the application of the compound microbial fertilizer in embodiment 3 can reduce the pH value of the soil by 2.58%, reduce the EC by 15.24%, increase the organic matter by 23.42%, increase the alkali-hydrolyzable nitrogen by 34.27%, significantly increase the rapidly available phosphorus by 36.95% and increase the rapidly available potassium by 19.33%. Compared with the conventional fertilization treatment, the application of the compound microbial fertilizer on the market can reduce the pH value of the soil by 2.58%, reduce the EC by 5.05%, increase the organic matter by 18.15%, increase the alkali-hydrolyzable nitrogen by 23.28%, significantly increase the rapidly available phosphorus by 21.80% and increase the rapidly available potassium by 19.51%. The results show that the application of the compound microbial fertilizer can improve available nutrients of the saline-alkali soil, reduce pH and EC, have soil fertility, and improve soil quality, wherein the application of the compound microbial fertilizer in embodiment 2 has the optimum effect on the improvement of saline soil.

Each embodiment in the description is described in a progressive way. The difference of each embodiment from each other is the focus of explanation. The same and similar parts among all of the embodiments can be referred to each other.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A compound microbial fertilizer, comprising citric acid fermentation raffinate, Arthrobacter fermentation liquid, urea, monoammonium phosphate and potassium sulphate: the proportion of each component: is (400-600) mL:(400-600) mL:(50-80) g:(50-80) g:(40-60) g; and the pH value of the compound microbial fertilizer is adjusted to 5.5-7.0 with ammonia water.

2. The compound microbial fertilizer according to claim 1, wherein the organic matter content of the citric acid fermentation raffinate is 280-300 g/L.

3. The compound microbial fertilizer according to claim 1, wherein the viable count in the Arthrobacter fermentation liquid is greater than or equal to 0.5×10⁸ cfu/ml.

4. The compound microbial fertilizer according to claim 1, wherein the mass concentration of the ammonia water is 31-35%.

5. A preparation method for the compound microbial fertilizer according to claim 1, comprising the following steps:
S1. preparing the Arthrobacter fermentation liquid: inoculating strains of activated Arthrobacter in a fermentation medium and fermenting in a shaker at 37° C., and at 180 r/min for 96 h, to obtain the Arthrobacter fermentation liquid;
S2, weighing: weighing the citric acid fermentation raffinate, the Arthrobacter fermentation liquid, the ammonia water, the urea, the monoammonium phosphate and the potassium sulphate according to volume-mass ratio;
S3, conducting primary mixing: adding the Arthrobacter fermentation liquid to the citric acid fermentation raffinate, to obtain the fermented mixed solution;
S4, conducting secondary mixing: adding the urea, the monoammonium phosphate and the potassium sulphate to the fermented mixed solution and stirring until the homogeneous solution is produced, to obtain the mixed solution; and
S5, adjusting the pH value: adding the ammonia water to the mixed solution and adjusting the pH value to 5.5-7.0, to obtain the compound microbial fertilizer.

6. A preparation method for the compound microbial fertilizer according to claim 5, wherein the fermentation medium comprises yeast extract, tryptone and distilled water, and the quality-volume ratio of the three is 1 g:2 g:200 ml.

7. A preparation method for the compound microbial fertilizer according to claim 5, wherein the pH value of the fermentation medium is 7.5-7.8.

8. A preparation method for the compound microbial fertilizer according to claim 5, wherein the content of nitrogen, phosphorus and potassium in the compound microbial fertilizer obtained through preparation is respectively 2.73%, 6.17% and 3.05%.

9. An application of the compound microbial fertilizer prepared by the preparation method of claim 5 in improving the crop yield and promoting the plant growth.

10. An application of the compound microbial fertilizer prepared by the preparation method of claim 5 in improving saline alkali soil.
